(19) United States
(12) Patent Application Publication
(10) Pub. No.: US 2019/0308278 A1
(43) Pub. Date: Oct. 10, 2019

(54) METHOD FOR EVALUATING A WELDED JOINT AND WELDED-JOINT EVALUATION DEVICE

(71) Applicant: NEWFREY LLC, New Britain, CT (US)

(72) Inventors: Bah EISSARA, Giessen (DE); Gerson MESCHUT, Paderborn (DE); Christian REIS, Giessen (DE)

(21) Appl. No.: 16/449,861

(22) Filed: Jun. 24, 2019

Related U.S. Application Data
(63) Continuation of application No. PCT/EP2018/050097, filed on Jan. 3, 2018.

(30) Foreign Application Priority Data
Jan. 5, 2017 (DE) 102017100157.3

(51) Int. Cl. B23K 31/12; B23K 9/095; B23K 9/20; B23K 11/00; B23K 11/25

(52) U.S. Cl. CPC B23K 31/125; B23K 9/0956; B23K 11/25; B23K 11/0053; B23K 9/20

(57) ABSTRACT

A method for evaluating a welded between a first component and a second component comprises the steps of: bringing a first electrical pole into contact with the first component and bringing a second electrical pole into contact with the second component with the welded joint in between the first and the second pole; applying a first electrical quantity to the welded joint such that an electrical current (i) flows through the welded joint; measuring a second electrical quantity at the first and the second pole; comparing a measured value (Ω_{F}; U_{F}) of the second electrical quantity with a reference value (Ω₀; U₀); and evaluating the welded joint on the basis of the comparison step.

### CROSS-REFERENCE TO RELATED APPLICATIONS

This application is a continuation of international application PCT/EP2018/050097, filed Jan. 3, 2018 which claims priority from German Patent Application No. 102017100157.3 filed Jan. 5, 2017, the disclosures of which are incorporated herein by reference in their entirety.

### BACKGROUND OF THE INVENTION

The present invention relates to a method for evaluating a welded joint (or weld connection) between a first component and a second component.

Furthermore, the present invention relates to an evaluation device for evaluating a welded joint between a first component and a second component.

In the field of welding technology, it is known to evaluate welded joints using a visual inspection.

When visually inspecting a completed welded joint, for example a weld seam is inspected with regard to whether there are any tool notches or marks from impacts, whether there are annealing colours, drag lines or the like, whether there is a smooth transition between the weld metal and the base material, whether the shape of a weld-seam surface is satisfactory, whether the seam is the same width over the entire length of the seam, etc.

For evaluating welded joints, in addition to non-destructive evaluation methods of this type, evaluation methods are also known in which the welded joint is subjected to mechanical loading.

For example, in the field of stud welding, it is known to evaluate a welded joint between a metal sheet and a stud welded to said sheet as follows. Using a mechanical evaluation apparatus, an axial pulling force is exerted on the stud, the evaluation device being supported on the metal sheet. The pulling force may for example be produced by a screw thread and a predetermined torque. If the stud welded joint withstands the axial pulling force applied, the stud welded joint can be deemed satisfactory. If the stud welded joint is not suitable, it will break. If this occurs, complex reworking is necessary. In particular in motor vehicle body construction, reworking of this kind is undesirable since vehicles having these defective stud welded joints have to be removed from the conveyor belt production process and machined separately.

### BRIEF SUMMARY OF THE INVENTION

Against this background, the problem addressed by the present invention is to provide an improved method for evaluating a welded joint and an improved welded joint evaluation device.

This problem is first solved by a method for evaluating a welded joint between a first component and a second component, comprising the steps of: bringing a first electrical pole into contact with the first component and bringing a second electrical pole into contact with the second component such that the welded joint is arranged between the first and the second pole; applying a first electrical quantity to the welded joint such that an electrical current flows through the welded joint; measuring a second electrical quantity at the first and the second pole; comparing a measured value of the second electrical quantity with a reference value; and evaluating the welded joint on the basis of the comparison step.

Furthermore, the above-mentioned problem is solved by an evaluation device for evaluating a welded joint between a first component and a second component, in particular for carrying out the method according to the invention, comprising a first contact portion for electrically contacting the first component at at least one contact point, a second contact portion for electrically contacting the second component at at least one second contact point, wherein the first contact portion and the second contact portion are arranged relative to one another such that the welded joint can be arranged between the at least one first contact point and the at least one second contact point; a connection apparatus for connecting the welded joint to an electrical power source designed to apply a first electrical quantity to the welded joint; a measuring apparatus for measuring a second electrical quantity at the first and the second contact portion; and a comparison apparatus, in which at least one reference value of the second electrical quantity is stored and which is designed to compare a measured value of the second electrical quantity with the reference value and to evaluate the welded joint on the basis of the comparison.

The evaluation method according to the invention is based on the following considerations. In a satisfactory welded joint, which in particular does not have any misalignments, cracks or other defects, a certain electrical resistance is produced between opposite ends of the welded joint. If, however, these kinds of defects are found in the welded joint, the electrical resistance is generally increased compared with the reference value.

It is now possible to allow an electrical current to flow across the welded joint and to then measure another electrical quantity, for example the voltage, in order to calculate the resistance therefrom, or to directly measure another electrical quantity such as the resistance itself or the electrical conductivity across the welded joint.

However, it is preferable for the electrical resistance or the electrical conductivity of the welded joint to be indirectly determined from the electrical quantities of current or voltage.

Here, the poles or the contact points thereof are preferably positioned in the immediate vicinity of the welded joint. The first electrical quantity can be applied to the welded joint such that an electrical current flows therethrough via the same poles or contact points. Preferably, however, this takes place at points that are further away from the welded joint than the poles or contact points at which the second electrical quantity is measured.

In the second preferred variant, different potentials arise at the poles or contact points, the potential difference of which may be a measured value of the second electrical quantity.

In the method according to the invention and the evaluation apparatus according to the invention, according to a preferred aspect it is provided that a first electrical quantity, for example in the form of a current or voltage, is applied to the welded joint, i.e. a current is generated across the welded joint.

According to a second aspect of the invention, however, it is also conceivable to evaluate the welded joint solely on the basis of the resistance or the electrical conductivity measured directly at the poles or contact points. Here, it is assumed that a defect-free welded joint has a reference resistance or reference conductivity, while a defective welded joint has an electrical resistance or electrical conductivity that differs therefrom.

The problem is solved in its entirety.

According to a particularly preferred embodiment, the welded joint is a stud welded joint between a metal-sheet component and a stud component protruding from the metal-sheet component, wherein the first electrical pole is brought into contact with a surface of the metal-sheet component beside the stud component and wherein the second electrical pole is brought into contact with an end face of the stud component facing away from the metal-sheet component.

In a stud welded joint, the weld seam is designed as a kind of weld lens between a surface portion of the metal-sheet component and a joining surface of the stud component that is axially opposite the end face. During the welding process, the stud component is generally pressed below a zero line, i.e. below a surface plane of the metal-sheet component, after the opposing surfaces have melted. Therefore, the welded joint generally also contains an annular weld bead, which extends around a shaft portion of the stud component at the base of the stud, adjacently to the metal-sheet component.

By contacting the end face of the stud component and a portion of the metal-sheet component adjacently to the stud component, the lenticular welded joint is positioned between the first pole and the second pole.

The first electrical quantity is preferably likewise established between the pole that contacts the end face of the stud component and another contact point that is further away from the stud component in the radial direction (relative to a longitudinal axis of the stud component) than the first electrical pole, which is used for measuring the second electrical quantity.

Generally, it is conceivable to evaluate the stud welded joint on the basis of a measured value of a second electrical quantity of this type if the metal-sheet component is contacted in just one location adjacently to the stud component. Generally, however, it is possible here that a welded joint defect located on a radially opposite side of the contact point cannot be detected well enough in such a case.

Therefore, it is preferable for the first electrical pole to be brought into contact with the surface of the metal-sheet component at at least two points that are offset over the periphery of the stud component.

In this way, it can be achieved that an electrical current flows between the second electrical pole and a first point on the metal-sheet component and another point on the metal-sheet component offset over the periphery of the stud component. As a result, the quality of the stud welded joint can be evaluated with a higher level of certainty.

It is particularly advantageous here for the first electrical pole to be contacted at three or four points on the surface of the metal-sheet component that are offset over the periphery of the stud component.

The plurality of points at which the metal-sheet component is contacted are preferably evenly spaced or distributed over the periphery of the stud component.

According to another preferred embodiment, for bringing the first and the second electrical pole into contact with the metal-sheet component and the stud component, respectively, a contact assembly is moved towards the metal-sheet component and the stud component in parallel with a longitudinal axis of the stud component until the contact is made.

As a result, the method according to the invention can preferably take place in one step. Furthermore, a contact assembly of this kind can for example be integrated in a weld head such that the welded joint can be evaluated immediately after a stud welding process has been carried out by means of the joining head.

In other embodiments, the contact assembly is integrated in a separate measuring assembly, for example.

The joining head and the contact assembly may optionally be guided by means of a robot.

It is also particularly preferred for the contact assembly to comprise at least one axially resiliently deflectable contact tip, the contact assembly moving towards the metal-sheet component and the stud component until the contact tip deflects.

By means of the measure whereby the contact assembly moves in the axial direction relative to the components until the contact tip deflects, it can be ensured that the electrical poles are reliably contacted.

Preferably, a contact tip is provided that contacts an end face of the stud component. Furthermore, the contact assembly preferably contains one contact tip, but in particular a plurality of contact tips, which are designed to contact the metal-sheet component.

In the evaluation device according to the invention, a contact tip for contacting the stud is preferably offset in the axial direction from a contact tip or a plurality of contact tips for contacting the metal-sheet component.

Here, the contact tips may be parts of the first or the second contact portion.

A contact portion of this kind and a second contact portion of this kind are preferably mechanically interconnected, but electrically insulated from one another, on the evaluation device according to the invention.

Overall, it is preferable for the first electrical quantity to be a voltage or current, in particular an alternating voltage or an alternating current. It is particularly preferable for the first electrical quantity to be an electrical current provided by a current source that provides a constant current.

In this embodiment, it is preferable for the second electrical quantity to be an electrical voltage that is measured at the poles or at the contact portions.

The comparison of the measured value of the second electrical quantity with a reference value may be a subtraction, but is preferably produced by forming a ratio between the measured value and the reference value.

Using a plurality of measurements, an evaluation diagram can be produced which puts the value of a comparison of this kind (e.g. a ratio) in relation to the magnitude or quantity of a defect in the welded joint.

Optionally, it is possible here to still tolerate certain deviations and to only give an evaluation according to which the welded joint is not suitable if there is a relatively significant difference (for example a very large ratio of the measured value of the second electrical quantity to the reference value).

It is clear that the above-mentioned features and those that are yet to be explained in the following can be used not only in the combination as stated, but also in other combinations or in isolation, without departing from the scope of the present invention.

### BRIEF DESCRIPTION OF THE DRAWINGS

Embodiments of the invention are shown in the drawings and are explained in greater detail in the following description. In the drawings:

FIG. 1 is a schematic view of a welding assembly comprising a stud welded joint and a contact assembly for carrying out the method according to the invention;

FIG. 2 is a view comparable to FIG. 1, having a defective welded joint;

FIG. 3 is a perspective view of an embodiment of a contact assembly for carrying out the method according to the invention;

FIG. 4 is a schematic plan view of a contact assembly and a connection apparatus as well as a measuring apparatus;

FIG. 5 is an alternative embodiment of a contact assembly comprising an alternative connection apparatus and a measuring apparatus;

FIG. 6 is a schematic longitudinal sectional view through a contact assembly of an evaluation device according to the invention;

FIG. 7 is a schematic plan view of a welded joint showing the electrical quantities; and

FIG. 8 is a diagram showing a characteristic curve for evaluating welded joints.

### DETAILED DESCRIPTION OF THE PREFERRED EMBODIMENTS

FIG. 1 schematically shows a welding assembly 10, which contains a first component 12 in the form of a metal-sheet component and a second component 14 in the form of a stud component. The stud component 14 extends along a longitudinal axis 16 which extends perpendicularly to a surface of the metal-sheet component 12. The stud component 14 is joined to the metal-sheet component 12 by means of a stud welding process. A lenticular welded joint 18 is formed between a former joining surface of the stud component 14 and a surface portion of the metal-sheet component 12, as indicated schematically in FIG. 1.

To evaluate the welded joint 18, a first electrical pole 20 is brought into contact with the metal-sheet component 12 at a first contact point 24 adjacently to the welded joint 18. A second electrical pole 22 is brought into contact with the stud component 14 at a second contact point 26, specifically at the end face (not described in greater detail) of the stud component 14 remote from the metal-sheet component 12.

The electrical poles 20, 22 may be part of a contact assembly 27, which is indicated schematically. A first electrical quantity 28, for example in the form of a current, can be introduced into the welded joint 18 by means of the contact assembly 27, as shown schematically by i in FIG. 1. The first electrical quantity is in particular provided by a current source by means of which a constant electrical current i is introduced into the welding assembly 10 such that the electrical current i flows through the welded joint 18.

A second electrical quantity and a measuring apparatus for measuring the second electrical quantity is shown schematically by 30. The measuring apparatus measures the second electrical quantity 30 at the first and the second pole 20, 22. The second electrical quantity 30 is preferably a voltage. The value of the voltage arises from an electrical resistance of the welding assembly, specifically in particular from the electrical resistance of the welded joint 18. The components 12, 14 are generally produced as homogeneous metal components, and have a generally very low electrical resistance. In the region of the welded joint 18, however, the electrical resistance can vary, specifically depending on the quality of the welded joint, i.e. depending on whether the welded joint 18 contains defects such as cavities, cracks, impurities or the like.

Here, it should also be noted that the first electrical quantity 28 can on one hand be fed into the welded joint 18 via the poles 20, 22. Alternatively, it is possible to feed the first electrical quantity 28 into the welded joint 18 via the second pole 22 and an additional contact point, the additional contact point being radially further away from the stud component than the first contact point 24.

The first electrical quantity 28 is shown by a dashed line in FIG. 1. In some cases, it may be sufficient not to feed an electrical quantity into the welded joint 18, but instead to merely passively measure a second electrical quantity via the poles 20, 22, for example the electrical resistance or the electrical conductivity.

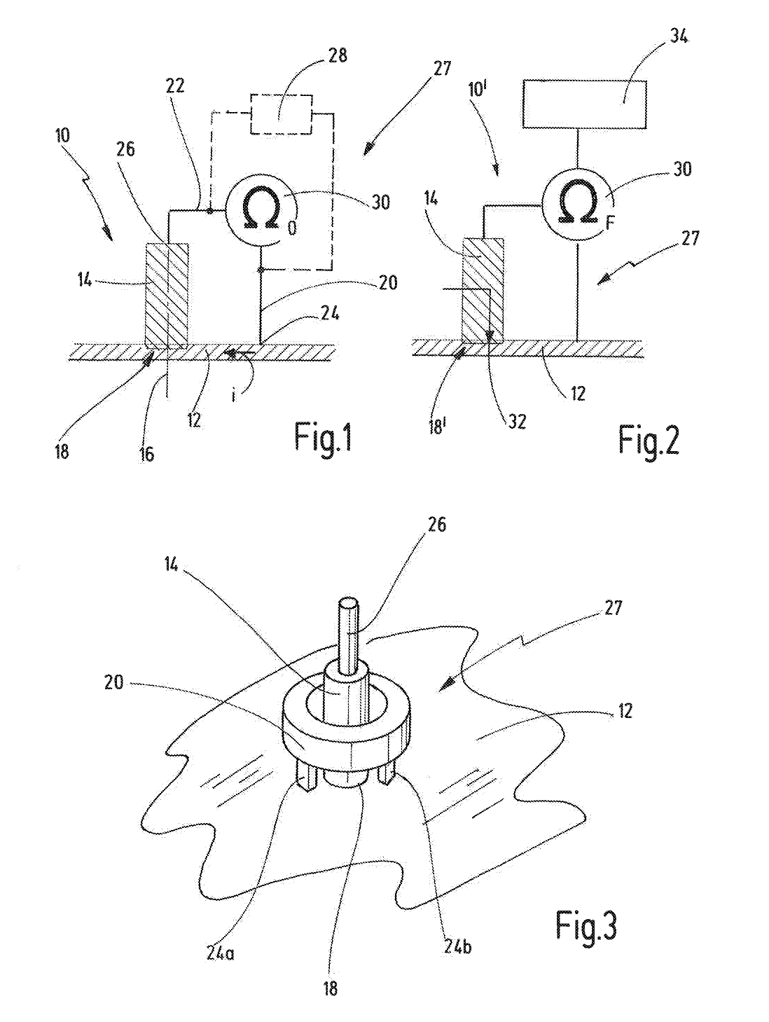

FIG. 2 shows the same contact assembly 27. FIG. 2 also shows that the welded joint 18′ may be formed with a defect 32.

While the starting point in FIG. 1 is an intact welded joint 18 that leads to a measured value of the second electrical quantity 30 that is the same as or close to a previously determined reference value (for example indicated by Ω₀ in FIG. 1), a measured value Ω_{F} of the second electrical quantity 30 that differs considerably from the reference value results in the assembly in FIG. 2 owing to the defect 32 in the welded joint 18′.

In a schematically shown comparison apparatus 34, the welded joint 18′ is therefore evaluated as defective.

By contrast, for the welded joint 18 in FIG. 1, the connected comparison apparatus 34 (not shown in FIG. 1) concludes that the welded joint 18 is acceptable.

FIG. 3 shows another embodiment of a contact assembly in which a second contact point 26 is produced by a contact tip that presses on the end face of the stud component 14. The first electrical pole is, however, produced by two or more contact points 24a, 24b, etc., distributed over the periphery of the stud component 14.

This ensures that an electrical current flowing through the welded joint 18 is composed of partial currents that flow through different segments of the welded joint 18 or peripheral portions of the welded joint 18 and are brought together in the first pole 20, shown schematically as a ring.

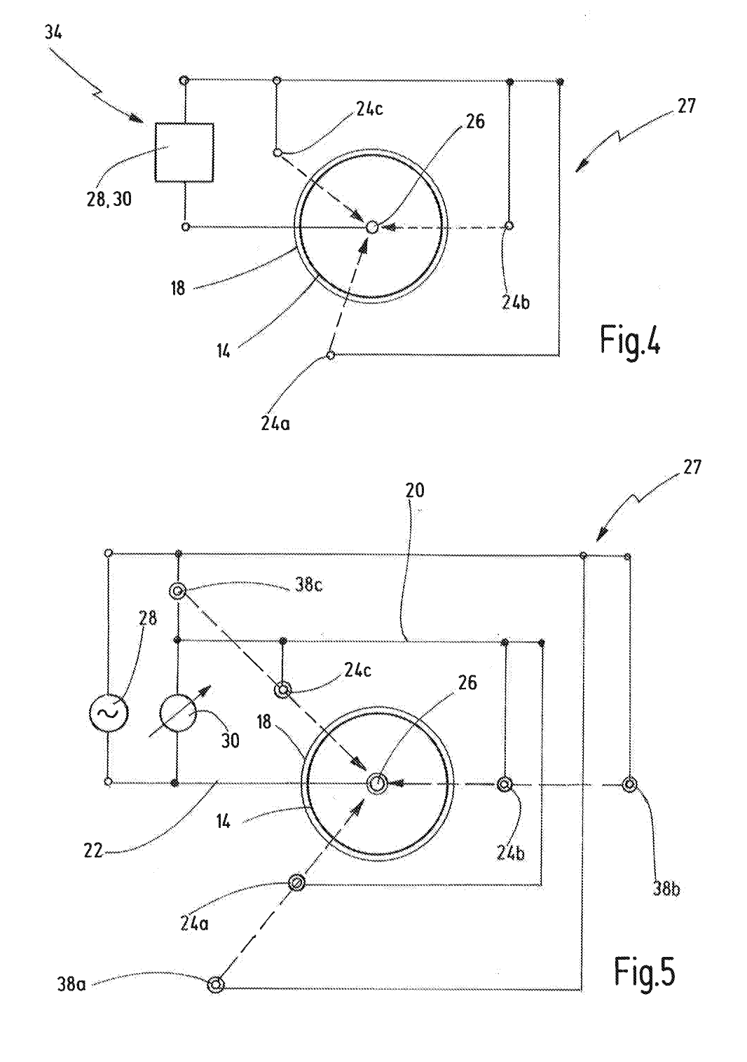

FIG. 4 is a schematic plan view of a contact assembly 27 in which three contact points 24a, 24b, 24c are arranged around a stud component 14 and are each spaced apart from one another by 120°, i.e. evenly over the periphery of the stud component 12.

An evaluation apparatus or comparison apparatus 34 feeds a first electrical quantity 28 into the welded joint 18 via the contact points 24a, 24b, 24c on the metal-sheet component 12 and a second contact point 26 on the end face of the stud component 14. The second electrical quantity 30 is also measured via the same contact points.

FIG. 5 shows an alternative embodiment, which corresponds to FIG. 4 in terms of the structure and mode of operation of the contact assembly. Like elements are therefore denoted by like reference signs. In the following, the basic differences are explained.

In addition to the contact points 24a, 24b, 24c, the contact assembly 27 in FIG. 5 thus contains a plurality of feed portions 38a, 38b, 38c that form a connection apparatus. The feed portions 38a, 38b, 38c are likewise distributed over the periphery of the stud component 14, but are each spaced further apart from the stud component in the radial direction than the contact points 24a, 24b, 24c.

A first electrical quantity 28 is fed into the welded joint 18 via the second contact point 26 and the feed portions 38a, 38b, 38c. A second electrical quantity 30 is measured at the contact points 24a, 24b, 24c connected to a common first pole 20 and the contact point 26 connected to a second electrical pole 22.

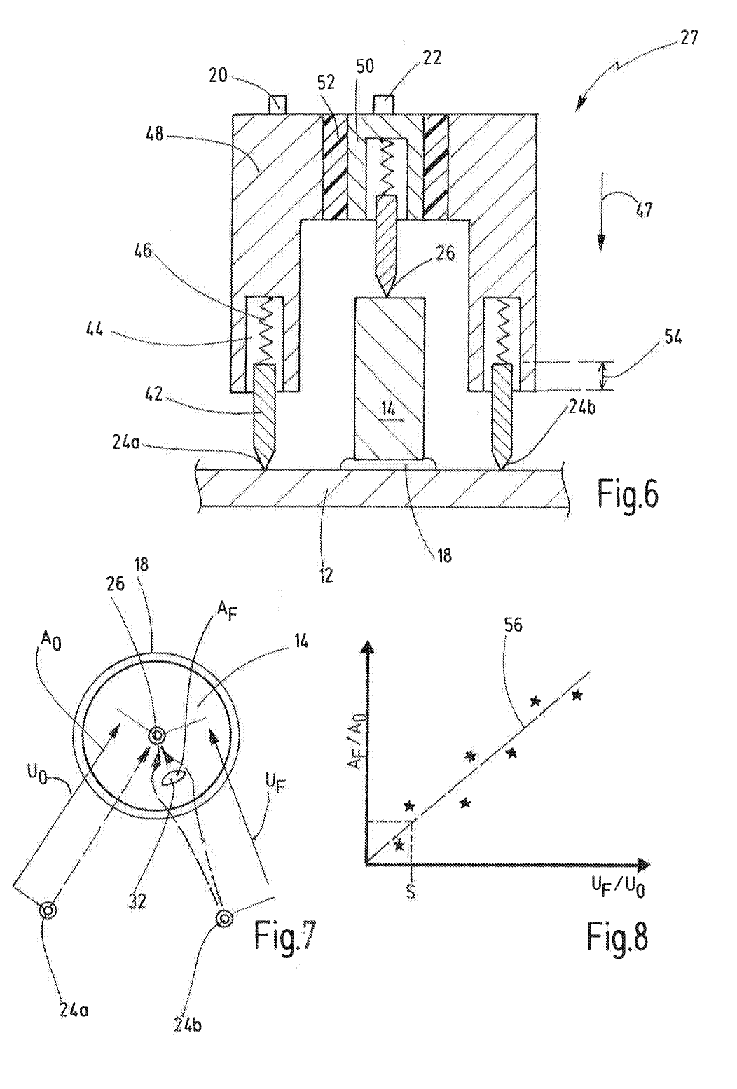

FIG. 6 shows a contact assembly 27, which corresponds to FIG. 3 in terms of the structure and mode of operation of the contact assembly 27. Like elements are therefore denoted by like reference signs.

FIG. 6 shows that the contact points 24, 26 can be contacted by respective contact tips 42 of the contact assembly 27. In this case, each contact tip 42 is mounted on the contact assembly such that it is guided in a contact-tip receiving portion 44 in the axial direction and is pretensioned counter to a contact direction 47 by means of an associated spring assembly 46.

The contact tips 42 for the contact points 24a, 24b, etc. are electrically connected to a first annular contact portion 48, on which the first electrical pole 20 can be formed. A contact tip for the second contact point 26 is resiliently deflectably mounted on a second inner contact portion 50, the second electrical pole 22 being formed on the second contact portion 50. The contact portions 48, 50 are electrically insulated from one another by means of an insulation portion 52.

As shown, the contact tips 42 for the contact points 24 are axially spaced apart from a contact tip for the contact point 26.

This can ensure that when the contact assembly 27 approaches the welded joint 18, the metal-sheet component 12 and the stud component 14 are contacted approximately simultaneously.

Any surface irregularities or the like can be compensated for by the resiliently deflectable contact tips. FIG. 6 schematically shows a deflection path by way of reference sign 54. Preferably, the second electrical quantity is only measured when the contact tips 42 are each deflected by a certain distance, which for example can be indirectly determined by the spacing between the first contact portion 48 and the metal-sheet component 12.

FIG. 7 schematically shows that, for a stud welded joint 18 between a stud component 14 and a metal-sheet component (not shown in greater detail in FIG. 7), different second electrical quantities U₀, U_{F} may result depending on whether or not there are any defects.

If it is assumed that an electrical current is fed into the welded joint 18 by a current source, for example a voltage Uo can be measured as the second electrical quantity via the contact points 26, 24a. FIG. 7 shows that there is not a defect between the contact points 24a, 26, and therefore the value U₀ substantially corresponds to a reference value. p FIG. 7 also shows that there is a defect 32 having a flaw A_{F} between a second pair of contact points 24b, 26. Therefore, via the contact points 24b, 26 a different voltage U_{F} is measured that is generally greater than the reference voltage U₀.

In the defect-free path between 24a and 26, FIG. 7 shows a defect base value A₀ that may for example correspond to a reference resistance.

FIG. 8 shows a diagram having a characteristic curve 56 in which values of A_{F}/A₀ are plotted against U_{F}/U₀.

Ideally, a linear characteristic curve results.

It should be noted that welded joints located below a threshold value S can be evaluated as being acceptable or “satisfactory”, whereas welded joints which lie outside the threshold value S and in which the ratio of U_{F} to U₀ is greater than S are evaluated as being defective.

Although exemplary embodiments of the present invention have been shown and described, it will be appreciated by those skilled in the art that changes may be made to these embodiments without departing from the principles and spirit of the invention, the scope of which is defined in the appended claims and their equivalents.

What is claimed is:

1. A method for evaluating a welded joint between a first component and a second component, the method comprising the steps of:
moving a first electrical pole into contact with the first component and moving a second electrical pole (into contact with the second component such that the welded joint is located between the first electrical pole and the second electrical pole;
applying a first electrical quantity to the welded joint such that an electrical current (i) flows through the welded joint;
measuring a second electrical quantity at the first electrical pole and the second electrical pole;
comparing a measured value (Ω_{F}; U_{F}) of the second electrical quantity with a reference value (Ω₀; U₀); and
evaluating the welded joint (18) on the basis of the comparing step.

2. A method according to claim 1, wherein the welded joint is a stud welded joint, the first component is a metal-sheet component and the second component is a stud component protruding from the metal-sheet component, and the first electrical pole is brought into contact with a surface of the metal-sheet component beside the stud component and the second electrical pole is brought into contact with an end face of the stud component facing away from the metal-sheet component.

3. A method according to claim 2, wherein the first electrical pole is brought into contact with the surface of the metal-sheet component at at least two points that are spaced around the periphery of the stud component.

4. A method according to claim 3, wherein the first electrical pole is brought into contact with the surface of the metal-sheet component at three or four points that are spaced around the periphery of the stud component.

5. A method according to claim 2, wherein the step of bringing the first electrical pole and the second electrical pole into contact with the metal-sheet component and the stud component, respectively, includes moving a contact assembly towards the metal-sheet component and the stud component in parallel with a longitudinal axis of the stud component until the contact is made.

6. A method according to claim 5, wherein the contact assembly includes at least one axially resiliently deflectable contact tip, and the step of moving the contact assembly towards the metal-sheet component and the stud component includes stopping that movement when the contact tip deflects when the contact is made.

7. A method according to claim 1, wherein the first electrical quantity is an alternating voltage or an alternating current (i).

8. An evaluation device for evaluating a welded joint between a first component and a second component, the evaluation device comprising:
a first contact portion for electrically contacting the first component at a contact point,
a second contact portion for electrically contacting the second component at a second contact point,
wherein the first contact portion and the second contact portion are arranged relative to one another such that the welded joint can be arranged between the first contact point and the second contact point;
a connection apparatus for connecting the welded joint to an electrical power source operable to apply a first electrical quantity to the welded joint;
a measuring apparatus for measuring a second electrical quantity at the first contact portion and the second contact portion, and a comparison apparatus, in which at least one reference value (Ω₀; U₀) of the second electrical quantity is stored, and which is operable to compare a measured value (Ω_{F}; U_{F}) of the second electrical quantity with the reference value (Ω₀; U₀) and to evaluate the welded joint on the basis of the comparison.
